(19) United States
(12) Patent Application Publication
(10) Pub. No.: US 2012/0008324 A1
(43) Pub. Date: Jan. 12, 2012

(54) SELF-CONTAINED MULTI-FUNCTION RETRO-REFLECTING MIRROR IN LAMP TUBE

(75) Inventors: Heinz W. Ito, Topsfield, MA (US); Robert Y. Pai, Ft. Lauderdale, FL (US)

(73) Assignee: OSRAM SYLANIA INC., Danvers, MA (US)

(21) Appl. No.: 13/117,083

(22) Filed: May 26, 2011

Related U.S. Application Data
(60) Provisional application No. 61/362,008, filed on Jul. 7, 2010.

(51) Int. Cl. H05B 33/02; H01J 9/00

(52) U.S. Cl. 362/260; 445/26

(57) ABSTRACT

A fluorescent lamp is provided that has a plurality of electroded tubes and a plurality of non-electroded tubes. The electroded tubes and the non-electroded tubes each have a proximal end and a distal end. Each proximal end is adjacent a base of the fluorescent lamp. A reflecting mirror is positioned in the proximal end of at least one of the non-electroded tubes or the electroded tubes. The reflecting mirror has a surface reflective of at least some frequencies of visible and ultra-violet light generated by the fluorescent lamp. The electroded tubes can also have a reflecting mirror positioned between the electrode and the end of the tube. In the latter case, an opposite surface of the reflecting mirror can include one or more of an end-of-life composition and/or a runner-up amalgam. A method of placing the reflecting mirror within a tube of a tubular fluorescent lamp is also provided.

### CROSS-REFERENCE TO RELATED APPLICATION

The present application claims priority of U.S. Provisional patent application No. 61/362,008, filed Jul. 7, 2010, entitled “SELF-CONTAINED MULTI-FUNCTION RETRO-REFLECTING MIRROR IN LAMP TUBE” and naming as inventors Heinz W. Ito and Robert Y. Pai, the entire contents of which are hereby incorporated by reference.

### TECHNICAL FIELD

The present invention relates to fluorescent lamps, and more specifically, to compact fluorescent lamps. Still more particularly, in relates to compact fluorescent lamps comprised of multiple tubes and having increased luminous flux.

### BACKGROUND

An increasing number of fluorescent lamps are those known as compact fluorescent lamps (CFL or CFLi). These lamps are generally of a small size and are made to fit into holders and/or fixtures that are typically used by incandescent lamps. They may or may not include electronic ballasts. While some compact fluorescent lamps are of the popular and well-known “twist” design, others may include multiple tubes, typically four or six tubes.

### SUMMARY

Conventional multiple tube compact fluorescent lamps typically suffer from low lumen output. Embodiments disclosed herein provide a compact fluorescent lamp that does not suffer from this issue, by placing at least one reflecting mirror in the proximal (i.e., lower) end of at least one non-electroded tube in the multiple tube lamp. The use of one or more mirrors in the non-electroded tubes greatly increases the luminous flux of the compact fluorescent lamp at very little increase in cost.

In an embodiment, there is provided a fluorescent lamp. The fluorescent lamp includes: a base; a plurality of electroded tubes, each electroded tube in the plurality of electroded tubes having a proximal end and a distal end, wherein a proximal end of an electroded tube is adjacent to the base; a plurality of non-electroded tubes, each non-electroded tube in the plurality of non-electroded tubes having a proximal end and a distal end, wherein a proximal end of a non-electroded tube is adjacent to the base; and a reflecting mirror positioned in the proximal end of at least one of the non-electroded tubes in the plurality of non-electroded tubes, wherein the reflecting mirror has a surface reflective of at least some frequencies of visible and ultra-violet light generated by the fluorescent lamp.

In a related embodiment, the reflecting mirror may include a plurality of reflecting mirrors, wherein each reflecting mirror in the plurality of reflecting mirrors is positioned in the proximal end of each non-electroded tube in the plurality of non-electroded tubes. In another related embodiment, the reflecting mirror may include a plurality of reflecting mirrors, wherein each reflecting mirror in the plurality of reflecting mirrors is positioned in the proximal end of each electroded tube in the plurality of electroded tubes. In yet another related embodiment, the reflecting mirror may include a plurality of reflecting mirrors, wherein each reflecting mirror in the plurality of reflecting mirrors is positioned in the proximal end of a tube in either the plurality of non-electroded tubes or in the plurality of electroded tubes.

In still another related embodiment, the reflecting mirror may have a reflecting surface. In a further related embodiment, the reflecting surface may include aluminum. In another further related embodiment, the reflecting surface may include silver.

In yet still another related embodiment, the fluorescent lamp may further include a filament, wherein the filament is located within the proximal end of the at least one of the non-electroded tubes in the plurality of non-electroded tubes that includes the reflecting mirror, and wherein the filament is held in place by the reflecting mirror. In a further related embodiment, the reflecting mirror may include a bottom surface and the fluorescent lamp may further include an end-of-life composition, wherein the end-of-life composition is sited on the bottom surface of the reflecting mirror. In a further related embodiment, the end-of-life composition may be sited on the reflecting mirror opposite the filament.

In still yet another related embodiment, the reflecting mirror may include a bottom surface and the fluorescent lamp may further include an end-of-life composition, wherein the end-of-life composition is sited on the bottom surface of the reflecting mirror.

In another embodiment, there is provided a method. The method includes locating a reflecting mirror within a proximal end of a tube of a tubular fluorescent lamp.

In a related embodiment, the method may further include placing a filament within the proximal end of the tube, such that the reflecting mirror holds the filament in a particular position within the tube. In another related embodiment, the method may further include locating an end-of-life composition on a bottom surface of the reflecting mirror. In still another related embodiment, the method may further include siting a runner-up amalgam on a bottom surface of the reflecting mirror.

In yet another related embodiment, locating may include locating a plurality of reflecting mirrors within a plurality of tubes of a tubular fluorescent lamp, wherein each reflecting mirror in the plurality of reflecting mirrors is located at the proximal end of a tube in the plurality of tubes. In a further related embodiment, locating may include locating a plurality of reflecting mirrors within a plurality of non-electroded tubes of a tubular fluorescent lamp, wherein each reflecting mirror in the plurality of reflecting mirrors is located at the proximal end of a non-electroded tube in the plurality of non-electroded tubes. In another further related embodiment, the method may further include placing a plurality of filaments within a plurality of tubes of a tubular fluorescent lamp, wherein each filament in the plurality of filaments is placed at the proximal end of a tube in the plurality of tubes, such that each reflecting mirror in the plurality of reflecting mirrors holds each filament in a particular position within each tube in the plurality of tubes. In yet another further related embodiment, the method may further include locating an end-of-life composition on each bottom surface of each reflecting mirror in the plurality of reflecting mirrors. In still another further related embodiment, the method may further include siting a runner-up amalgam on each bottom surface of each reflecting mirror in the plurality of reflecting mirrors.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a plan view of a multiple tube fluorescent lamp according to embodiments described herein.

FIG. 2 is a view of a reflecting mirror as mounted within a multiple tube fluorescent lamp according to embodiments described herein.

FIG. 3 is a view of a reflecting mirror as alternatively mounted within a multiple tube fluorescent lamp according to embodiments described herein.

FIG. 4 is a perspective of a multiple tube fluorescent lamp according to embodiments described herein.

FIG. 5 is a view of a reflecting mirror applied to an electroded tube of a multiple tube fluorescent lamp according to embodiments described herein.

FIG. 6 is a flowchart of a method of providing a reflecting mirror in a fluorescent lamp, according to embodiments described herein.

### DETAILED DESCRIPTION

For purposes of this application, it is to be understood that when an element or layer is referred to as being “on,” “connected to” or “coupled to” another element or layer, it can be directly on, connected to or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. The term “and/or” includes any and all combinations of one or more of the associated listed items. Although the terms “first,” “second,” “third” etc. may be used to describe various elements, components, regions, layers and/or sections, these elements, components, regions, layers and/or sections are not to be limited by theses terms as they are used only to distinguish one element, component, region, layer or section from another element, component, region, layer or section. Thus, a first element, component, region, layer or section could be termed a second element, component, region, layer or section without departing from the scope and teachings of the present invention.

Spatially relative terms, such as “beneath,” below,” upper,” “lower,” “above” and the like may be used herein for ease of description to describe one element or feature's relationship to another element(s) or feature(s) as illustrated in the drawings. These spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. For example, as used herein, the singular forms “a,” “an” and “the” are intended to include the plural forms as well, unless the context clearly indicates otherwise. It will be further understood that the terms, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

For a better understanding of embodiments of the present invention, together with other and further objects, advantages and capabilities thereof, reference is made to the following disclosure and appended claims taken in conjunction with the above-described drawings.

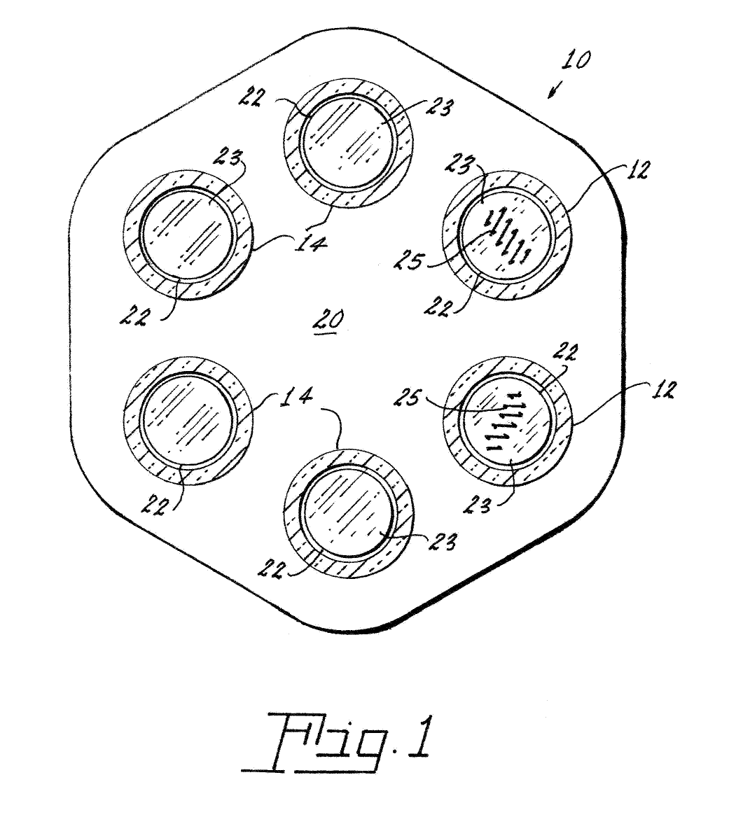

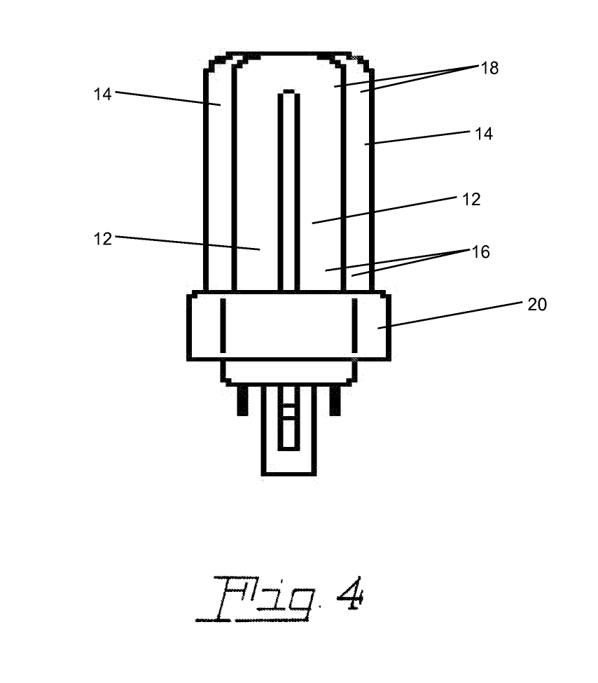

Referring now to the drawings with greater particularity there is shown in FIG. 4 a tubular-style fluorescent lamp 10 comprising a plurality of electroded tubes 12 and a plurality of non-electroded tubes 14. The plurality of electroded tubes 12 and the plurality of non-electroded tubes 14 each have a proximal end 16 and a distal end 18. Each proximal end 16 of each tube in both the plurality of electroded tubes 12 and in the plurality of non-electroded tubes 14 is adjacent a base 20. The orientation of the plurality of electroded tubes 12 to the plurality of non-electroded tubes 14 is most clearly seen in FIG. 1, which shows a plan view of the fluorescent lamp 10.

As seen in FIGS. 1, 2, 3, and 5, a reflecting mirror 22 is positioned in a proximal end 16 of a non-electroded tube in the plurality of non-electroded tubes 14. In some embodiments, some subset of the plurality of non-electroded tubes 14 includes a reflecting mirror 22. Alternatively or additionally, in some embodiments, all of the non-electroded tubes in the plurality of non-electroded tubes 14 includes a reflecting mirror 22. Further, in some embodiments, as shown in FIG. 1, some subset of the plurality of electroded tubes 12 includes a reflective mirror 22. Alternatively or additionally, in some embodiments, all of the electroded tubes in the plurality of electroded tubes 12 includes a reflecting mirror 22.

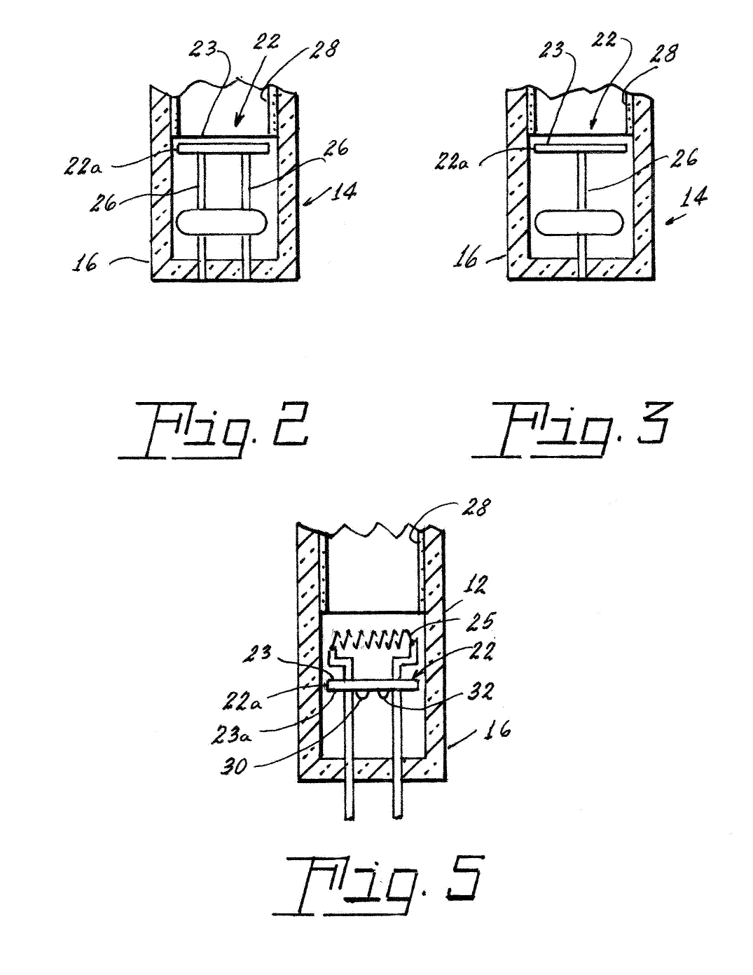

In some embodiments, the reflecting mirror 22 has a surface 23 reflective of at least some of the frequencies of visible and ultra-violet light that are generated within the fluorescent lamp 10 when the fluorescent lamp 10 is operating. In some embodiments, the reflecting mirror 22 is a flat disk 22a connected on top of, and perpendicular to, one (see FIG. 3) or two (see FIG. 2) lead-in wires 26. In some embodiments, the lead-in wires 26 are made of nickel-iron-chromium alloy having a glass-matching thermal expansion coefficient, though of course other materials may be, and in some embodiments are, used for the lead-in wires 26. Alternatively, or additionally, in some embodiments, the reflecting mirror 22 may have a substantially flat shape, such that some portion of the reflecting mirror 22 is flat while some other portion of the reflecting mirror 22 is non-flat (i.e., rounded, curved, bent, etc.). Alternatively, or additionally, in some embodiments, the reflecting mirror 22 may have a substantially non-flat (i.e., rounded, curved, bent, etc.) shape. In some embodiments, at least one non-electroded tube in the plurality of non-electroded tubes 14 has a reflecting mirror 22 having a flat disk 22a, while at least one other non-electroded tube in the plurality of non-electroded tubes 14 has a reflecting mirror 22 of a different shape, such as but not limited to those described herein.

The reflecting mirror 22 may be, and in some embodiments is, formed from and/or is coated with a material that is inert in a low-pressure discharge lamp, such as the fluorescent lamp 10, and has the surface 23 provided with the reflecting material. Suitable materials include, but are not limited to, aluminum or silver-plated stainless steel. The dimensions of the reflecting mirror 22 are such that the reflecting mirror is able to fit inside the non-electroded tube of the plurality of non-electroded tubes 14. Thus, for example, in embodiments where the reflective mirror 22 is a flat disk 22a, a diameter of the flat disk 22a is slightly smaller than the inner diameter of the non-electroded tube in the plurality of non-electroded tubes 14. In other embodiments, the reflecting mirror 22 is sized such that at least a portion of the reflecting mirror 22 comes into contact with an inner surface of the non-electroded tube in the plurality of non-electroded tubes 14. Alternatively, or additionally, the reflecting mirror 22 is sized such that no portion of the reflecting mirror 22 comes into contact with an inner surface of the non-electroded tube in the plurality of non-electroded tubes 14.

In some embodiments, the lead-in wires 26 may be either pinched into the material (e.g., glass) of the non-electroded tube in the plurality of non-electroded tubes 14 when forming a pinch seal. Alternatively, or additionally, the lead-in wires 26 may be sealed into the base 20 and/or tube end of the fluorescent lamp 10 if separate flare mounts are used, or may otherwise be placed into the non-electroded tube in the plurality of non-electroded tubes 14. A generic sealing system is illustrated in FIGS. 2 and 3. External ends of the lead-in wires 26 are, for example, cut flush with the tube end unless the reflecting mirror 22 is also used as a holder for a filament 25, in which case the lead-in wires 26 extend beyond the tube end to supply the necessary electrical connection.

The surface 23 of the reflective mirror 22 reflects visible and ultraviolet light that is generated when the fluorescent lamp 10 is operating and that travels in the direction of the base 20 and/or tube ends (i.e., back towards the fluorescent lamp 10), thus acting as a retro-reflecting mirror. Some of the reflected visible light will pass through the glass tubes outside of the base 20, thus contributing to the useful luminous flux of the fluorescent lamp 10. Most of the reflected ultraviolet light will reach a phosphor coating 28 and generate additional visible light. Absent a reflective mirror 22, light radiated toward a tube end will be lost in the base 20 or, in the case of the ultraviolet light, will be lost in a glass end of the non-electroded tube that is not coated with the phosphor coating 28.

The luminous flux of low-pressure discharge lamps depends on the mercury vapor pressure in the discharge vessel. In non-amalgam lamps, the cold spot temperature controls the mercury vapor pressure. In different burning positions, different parts of a lamp envelope may act as effective cold spots in an undesirable way, causing luminous flux variations in burning positions. By judicial placement and selection of proper thicknesses of a plurality of reflecting mirrors 22, the plurality of reflecting mirrors 22 may act as an auxiliary cold spot for particular burning orientations. This may reduce or eliminate undesired burning orientation dependent variations in luminous flux.

If the reflecting mirror 22 is made from an electrically non-conducting material (for example, but not limited to, ceramic), it may be used to keep the lead-in wires 26 and, in embodiments including the filament 25, the filament 25 in proper position, replacing the glass bead and/or other structure typically used for this purpose.

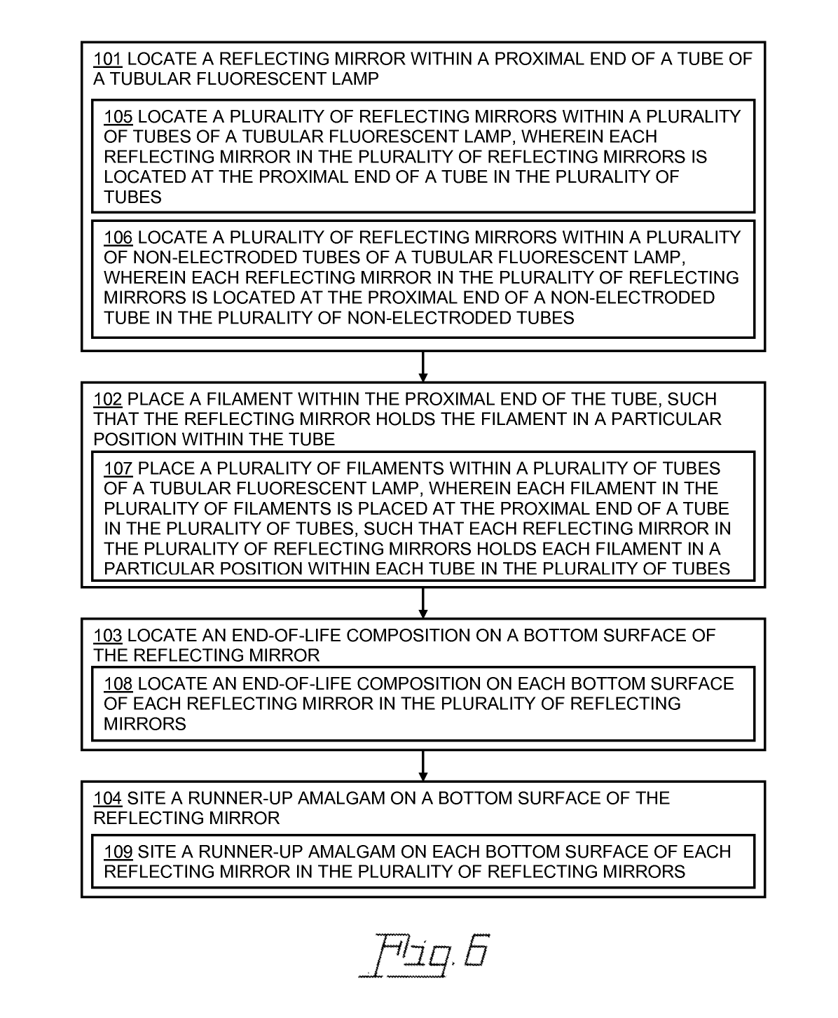

When employed with the filament 25, a bottom surface 23a of the reflecting mirror 22 may be used as the location for an end-of-life composition 30, such as but not limited to TiH₂, as shown in FIG. 5. The reflecting mirror 22 will thus shield (and/or substantially shield) the end-of-life composition 30 from direct radiation from the filament 25, avoiding premature activation of the end-of-life composition 30.

In embodiments including an amalgam, the bottom surface 23a of the reflecting mirror 22 may also be used as the site for a runner-up amalgam 32 by depositing thereon a defined amount of indium or a similar amalgam partner, thus replacing an extra run-up flag welded to the lead-in wires 26.

Though the reflecting mirror 22 is described and shown with respect to a fluorescent lamp 10 including a triple tube arrangement, such as but not limited to a DULUX T/E type fluorescent lamp available from OSRAM SYLVANIA, it may be applied to any other type of tubular lamp without departing from the scope of the invention.

FIG. 6 shows a flowchart of a method for placing a mirror, such as the reflecting mirror 22 described herein, with a fluorescent lamp, as described herein. It will be appreciated by those of ordinary skill in the art that unless otherwise indicated herein, the particular sequence of steps described is illustrative only and may be varied without departing from the spirit of the invention. Thus, unless otherwise stated, the steps described below are unordered, meaning that, when possible, the steps may be performed in any convenient or desirable order.

In some embodiments, a reflecting mirror (such as but not limited to the reflecting mirror 22) is located within a proximal end (such as but not limited to the proximal end 16) of a tube of a fluorescent lamp (such as but not limited to the fluorescent lamp 10), step 101. The fluorescent lamp may be, and in some embodiments is, a tubular fluorescent lamp.

In some embodiments, a plurality of reflecting mirrors is located within a plurality of tubes (such as but not limited to the plurality of electroded tubes 12 and/or the plurality of non-electroded tubes 14) of a tubular fluorescent lamp, wherein each reflecting mirror in the plurality of reflecting mirrors is located at the proximal end of a tube in the plurality of tubes, step 105. In some embodiments, a plurality of reflecting mirrors is located within a plurality of non-electrodeded tubes (such as but not limited to the plurality of non-electroded tubes 14) of a tubular fluorescent lamp, wherein each reflecting mirror in the plurality of reflecting mirrors is located at the proximal end of a non-electroded tube in the plurality of non-electroded tubes, step 106.

In some embodiments, a filament (such as but not limited to the filament 25) is placed within the proximal end of the tube, such that the reflecting mirror holds the filament in a particular position within the tube, step 102. A plurality of filaments may be placed within a plurality of tubes of a tubular fluorescent lamp, wherein each filament in the plurality of filaments is placed at the proximal end of the tube in the plurality of tubes, such that each reflecting mirror in the plurality of reflecting mirrors holds each filament in a particular position within each tube in the plurality of tubes, step 107.

In some embodiments, an end-of-life composition (such as but not limited to the end-of-life composition 30) is located on a bottom surface (such as but not limited to the bottom surface 23a) of the reflecting mirror, step 103. An end-of-life composition may be located on each bottom surface of each reflecting mirror in the plurality of reflecting mirrors, step 108.

Alternatively or additionally, in some embodiments, a runner-up amalgam (such as but not limited to the runner-up amalgam 32) is sited on a bottom surface of the reflecting mirror, step 104. A runner-up amalgam may be located on each bottom surface of each reflecting mirror in the plurality of reflecting mirrors, step 109.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A fluorescent lamp comprising:
a base;
a plurality of electroded tubes, each electroded tube in the plurality of electroded tubes having a proximal end and a distal end, wherein a proximal end of an electroded tube is adjacent to the base;
a plurality of non-electroded tubes, each non-electroded tube in the plurality of non-electroded tubes having a proximal end and a distal end, wherein a proximal end of a non-electroded tube is adjacent to the base; and
a reflecting mirror positioned in the proximal end of at least one of the non-electroded tubes in the plurality of non-electroded tubes, wherein the reflecting mirror has a surface reflective of at least some frequencies of visible and ultra-violet light generated by the fluorescent lamp.

2. The fluorescent lamp of claim 1, wherein the reflecting mirror comprises:
a plurality of reflecting mirrors, wherein each reflecting mirror in the plurality of reflecting mirrors is positioned in the proximal end of each non-electroded tube in the plurality of non-electroded tubes.

3. The fluorescent lamp of claim 1, wherein the reflecting mirror comprises:
a plurality of reflecting mirrors, wherein each reflecting mirror in the plurality of reflecting mirrors is positioned in the proximal end of each electroded tube in the plurality of electroded tubes.

4. The fluorescent lamp of claim 1, wherein the reflecting mirror comprises:
a plurality of reflecting mirrors, wherein each reflecting mirror in the plurality of reflecting mirrors is positioned in the proximal end of a tube in either the plurality of non-electroded tubes or in the plurality of electroded tubes.

5. The fluorescent lamp of claim 1, wherein the reflecting mirror has a reflecting surface.

6. The fluorescent lamp of claim 5, wherein the reflecting surface comprises aluminum.

7. The fluorescent lamp of claim 5, wherein the reflecting surface comprises silver.

8. The fluorescent lamp of claim 1, further comprising:
a filament, wherein the filament is located within the proximal end of the at least one of the non-electroded tubes in the plurality of non-electroded tubes that includes the reflecting mirror, and wherein the filament is held in place by the reflecting mirror.

9. The fluorescent lamp of claim 8, wherein the reflecting mirror includes a bottom surface and wherein the fluorescent lamp further comprises:
an end-of-life composition, wherein the end-of-life composition is sited on the bottom surface of the reflecting mirror.

10. The fluorescent lamp of claim 9, wherein the end-of-life composition is sited on the reflecting mirror opposite the filament.

11. The fluorescent lamp of claim 1, wherein the reflecting mirror includes a bottom surface and wherein the fluorescent lamp further comprises:
an end-of-life composition, wherein the end-of-life composition is sited on the bottom surface of the reflecting mirror.

12. A method comprising:
locating a reflecting mirror within a proximal end of a tube of a tubular fluorescent lamp.

13. The method of claim 12, further comprising:
placing a filament within the proximal end of the tube, such that the reflecting mirror holds the filament in a particular position within the tube.

14. The method of claim 12, further comprising:
locating an end-of-life composition on a bottom surface of the reflecting mirror.

15. The method of claim 12, further comprising:
siting a runner-up amalgam on a bottom surface of the reflecting mirror.

16. The method of claim 12, wherein locating comprises:
locating a plurality of reflecting mirrors within a plurality of tubes of a tubular fluorescent lamp, wherein each reflecting mirror in the plurality of reflecting mirrors is located at the proximal end of a tube in the plurality of tubes.

17. The method of claim 16, wherein locating comprises:
locating a plurality of reflecting mirrors within a plurality of non-electroded tubes of a tubular fluorescent lamp, wherein each reflecting mirror in the plurality of reflecting mirrors is located at the proximal end of a non-electroded tube in the plurality of non-electroded tubes.

18. The method of claim 16, further comprising:
placing a plurality of filaments within a plurality of tubes of a tubular fluorescent lamp, wherein each filament in the plurality of filaments is placed at the proximal end of a tube in the plurality of tubes, such that each reflecting mirror in the plurality of reflecting mirrors holds each filament in a particular position within each tube in the plurality of tubes.

19. The method of claim 16, further comprising:
locating an end-of-life composition on each bottom surface of each reflecting mirror in the plurality of reflecting mirrors.

20. The method of claim 16, further comprising:
siting a runner-up amalgam on each bottom surface of each reflecting mirror in the plurality of reflecting mirrors.
